(19) United States
(12) Patent Application Publication
(10) Pub. No.: US 2025/0216277 A1
(43) Pub. Date: Jul. 3, 2025

(54) METHODS AND SYSTEMS FOR MEASURING MOTOR SHAFT TORQUE

(71) Applicant: DANA TM4 ITALIA S.R.L., Arzignano (IT)

(72) Inventors: Walter FAEDO, Vestenanova (IT); Mirko SGAGGIO, Vestenanova (IT)

(21) Appl. No.: 18/397,212

(22) Filed: Dec. 27, 2023

(51) Int. Cl. G01L 3/04

(52) U.S. Cl. CPC G01L 3/04

(57) ABSTRACT

Methods and systems are provided for an electric motor. The system includes a first sensor arranged at a first end of a motor and a second sensor at a second end of the motor, opposite the first and a controller with instructions stored in memory that cause the controller to determine a deflection of a shaft of the motor and calculate a torque of the motor.

### FIELD

The present description relates generally to measuring a motor shaft torque. More specifically, the present disclosure relates to a sensing system for measuring the motor shaft torque.

### BACKGROUND AND SUMMARY

The inclusion of electric motors in vehicle is becoming increasingly ubiquitous. Electric motors may be connected through a rotor shaft to a load, such as a gear. A position sensor may be positioned on an opposite side of the electric motor, relative to the load. The position sensor may provide feedback for driving the motor through its speed and torque control loops.

Current systems include complex multi-input tables mapping frequency, current, and voltage against torque. The tables are stored in memory and generated via motor torque sensors that are not included outside of a lab setting. Thus, real-world examples may present issues as conditions may not match lab settings, resulting in an estimate of torque that may be inaccurate. Additionally, lab settings may not account for aging, temperature, debris, and other factors that may present unrealistic parameters for monitoring and/or predicting in a lab setting.

The issues described above may be addressed by a system comprising at least two sensors. The system includes a first sensor arranged at a first end of the motor and a second sensor at a second end of the motor, opposite the first end. The system further includes a controller with instructions stored in memory that cause the controller to determine a mechanical torsional deflection of a shaft of the motor and calculate a torque of the motor. In this way, the torque may be calculated via feedback from the sensors, which may enhance operation of the motor.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of a vehicle system with an electric motor.

FIG. 2 shows a cross-section of the electric motor.

FIG. 3 shows an offset correction between sensors of the electric motor.

FIG. 4 shows a method for measuring torque of the electric motor.

### DETAILED DESCRIPTION

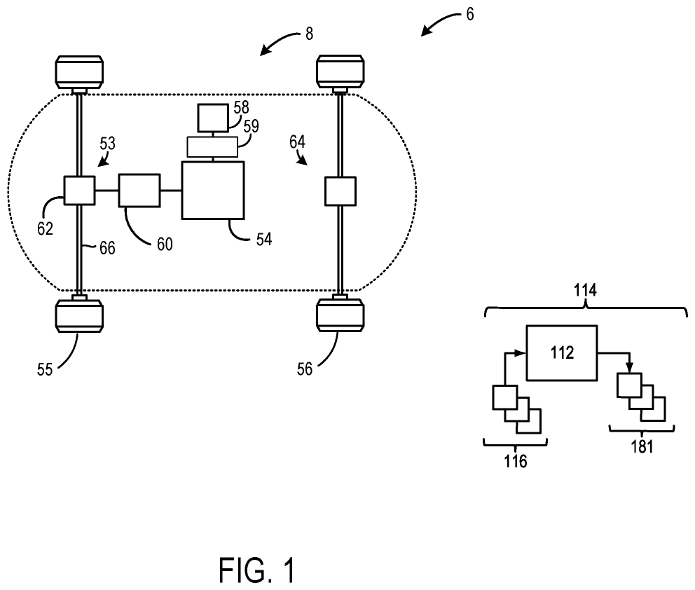

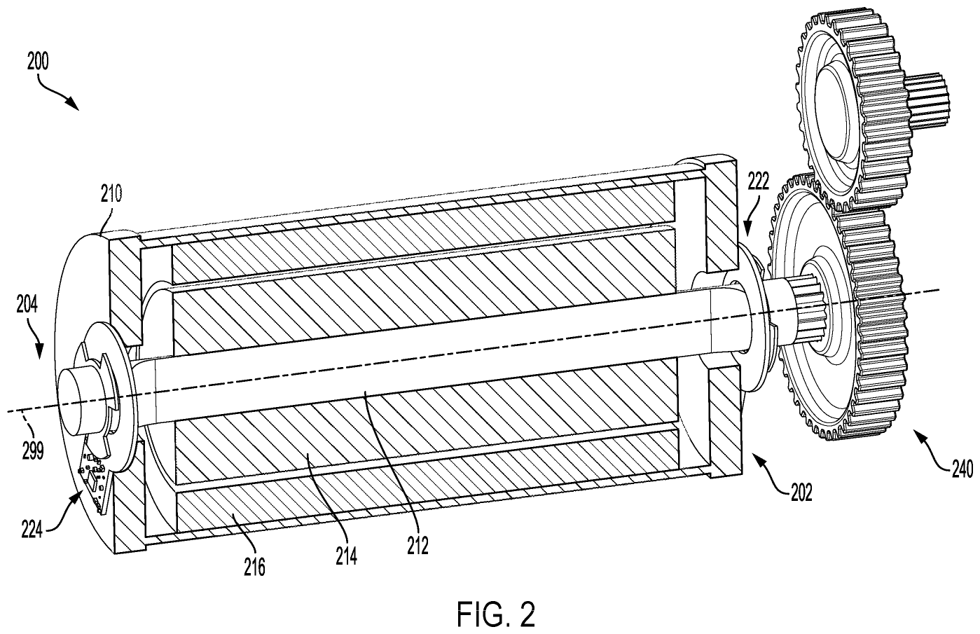

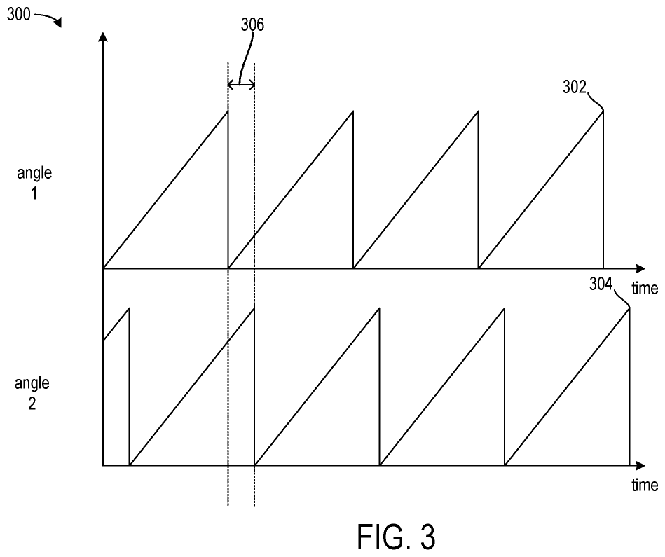

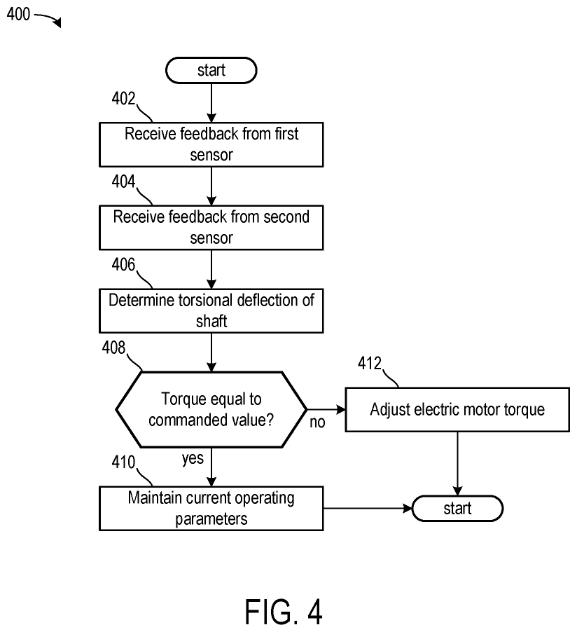

The following description relates to methods and systems for a vehicle including an electric motor. An example vehicle is shown in FIG. 1. FIG. 2 shows a cross-section of the electric motor. FIG. 3 shows an offset correction between sensors of the electric motor. FIG. 4 shows a method for measuring torque of the electric motor.

FIG. 1 shows a schematic depiction of a vehicle 6 with a powertrain 8 that may include a prime mover 54 and a transmission 60. Herein, the prime mover 54 is interchangeably referred to as an electric motor 54 (e.g., a traction motor). In such an example, the electric motor 54 may be electrically connected to an energy storage device 58 (e.g., one or more traction batteries, capacitors, fuel cells, combinations thereof, and the like) via an inverter 59. Further, the electric motor 54 may be configured to operate as a generator, during selected conditions, to provide electrical power to charge the energy storage device 58, for example. The inverter 59 may be configured to adjust operation of the electric motor in response to torque measurement thereof, as described in greater detail herein.

In some examples, the vehicle 6 may include an internal combustion engine (ICE) configured to operate in combination with or independently of the electric motor 54. In this way, the vehicle 6 may be configured as a hybrid vehicle in some examples.

In the illustrated example, the transmission 60 delivers mechanical power to a differential 62 of an axle assembly 53. However, it will be appreciated that the transmission 60 may additionally or alternatively deliver mechanical power to the other axle 64 in the vehicle 6. Still further, in other examples, the transmission may be incorporated into one of the axles to form an electric axle assembly. In the electric axle example, an internal combustion engine may provide mechanical power to the other axle, in some cases.

The transmission 60 (e.g., a gearbox) may be configured to receive torque from the prime mover 54 via a shaft (e.g., a drive shaft) and/or other suitable mechanical component. The transmission 60 may output torque to the differential 62. The output torque may be moderated based on selective adjustments to gear engagement at the transmission 60 to accommodate desired vehicle operation. Torque from the transmission 60 may drive rotation of the differential 62, which may in turn drive rotation of axle shafts 66 which are rotationally coupled to vehicle wheels 55.

A controller 112 may form a portion of a control system 114. The control system 114 is shown receiving information from sensors 116 and sending control signals to actuators 181. As one example, the sensors 116 may include sensors such as a battery level sensor, a clutch activation sensor, one or more positions sensors of the electric motor, etc. The controller 112 may receive input data from the sensors, process the input data via a processor, and trigger the actuators in response to the processed input data based on instruction or code programmed therein corresponding to one or more routines. In some examples, the controller 112 may include instructions that send a command signal to the inverter 59 to adjust operation of the prime mover 54, which may change a speed of the wheels 55 and/or wheels 56.

FIG. 2 shows an embodiment 200 of an electric motor 210 coupled to a load 240. In one example, the electric motor 210 is identical to the prime mover 54 of FIG. 1. The load 240 is identical to the transmission 60 of FIG. 1. The load 240 may be a gear as illustrated in the example of FIG. 2. In some examples, additionally or alternatively, the load 240 is an external load. The electric motor 210 may include a shaft 212, a rotor 214, and a stator 216. The shaft 212 may be configured to rotate about a central axis 299 of the electric motor 210. The shaft 212 may be solid or hollow. The shaft 212 may include teeth or other engaging elements arranged on an extreme end thereof coupled to the load 240.

The rotor 214 may be positioned radially outward from the shaft 212. The rotor 214 may be configured to rotate the shaft 212 in response to a magnetic field generated by the stator 216. The stator 216 may be positioned radially outward from the shaft 212 and electrically coupled to an inverter, such as inverter 59 of FIG. 1. As such, signals from the inverter may control operation of the electric motor 210, which may adjust torque transfer to the load 240. During some conditions, the load 240 may transfer torque through the shaft 212 and to the electric motor 210.

It may be desired to measure torque through the shaft 212 in real-time to adjust electric motor operation. A first sensor 222 may be arranged at a first side 202 of the electric motor 210. A second sensor 224 may be arranged at a second side 204 of the electric motor 210, the second side 204 opposite the first side 202. In one example, the first sensor 222 and the second sensor 224 are arranged on the shaft 212. Additionally or alternatively, the first sensor 222 and the second sensor 224 are positioned outside of a housing of the electric motor 210. As such, fluids within the electric motor 210 may not contact the first sensor 222 and/or the second sensor 224, in one example embodiment. The first sensor 222 and the second sensor 224 may touch (e.g., make contact with) exterior surfaces of the housing of the electric motor 210. In some embodiments, additionally or alternatively, the first sensor 222 and/or the second sensor 224 may be mounted on a portion of the shaft 212 within the housing of the electric motor 210.

In one example, the first sensor 222 and the second sensor 224 are position sensors. The first sensor 222 and/or the second sensor 224 may be a sensor with 10-bit (0.35 deg) or 12-bit (0.09 deg) resolution, which may reduce a manufacturing cost and complexity of the electric motor assembly. When external torque is applied to the electric motor 210 by the load 240, and the electric motor 210 produces its torque, and there is a torsional deflection of the shaft 212 between the first side 202 and the second side 204. The torsional deflection may be calculated, as described below. Additionally, the multi-sensor arrangement may provide redundant speed/position feedback of the motor. In this way, feedback from the first sensor 222 may be cross-checked with feedback from the second sensor 224, or vice-versa, to provide accurate operation of the electric motor 210.

In some systems, the inverter controls the electric motor to provide an output to a gearbox or directly to a wheel/other device. The electric motor may be operated as a motor or as a generator depending on the external torque, generated by kinetic energy of the vehicle. During braking, the inverter functions as a generator and during acceleration/cruising the inverter functions as a motor.

With reference to FIG. 2, positions sensors 222 and 224 are mounted on both sides of the rotor of the motor to sense the shaft deflection under load conditions. The first sensor 222 may be a through-shaft type to allow the shaft connection with the load gears 240. The second sensor 224 may be either the through-shaft type or an end-shaft type. The second sensor 224 may be an end-shaft type since a connection with a load is not present on the second side 204. On both sides the motor shaft and housing may provide mechanical attachment points to ensure the installation of the position sensor target and electronic board. Sensor target and board shall be integral and fixed with rotor/shaft and stator/housing, respectively.

Turning now to FIG. 3, it shows a graph 300 illustrating an offset 306 between a first sensor angle 302 and a second sensor angle 304. If the two position sensors are not angularly aligned within a determined value due to mechanical mounting limitations or assembly tolerances during manufacturing process, there will be an offset between the two angles. To correct this, it is possible to provide a calibrating procedure of the system to evaluate the offset angle based on feedback from the two sensors.

The calibrating procedure may be executed at least one time (start or end of life) or when no load condition is detected (torque within a threshold value of zero is measured, and offset can be re-checked and updated) multiple times. The position from the first sensor and the second sensor is measured without load applied to the shaft and the difference (e.g., calibration value) may be stored in memory. The calibration value may be applied to future values provided by the sensors to correct the offset.

Turning now to FIG. 4, it shows a method 400 for measuring a torque of the shaft of the electric motor. Instructions for carrying out method 400 may be executed by a controller based on instructions stored on a memory of the controller and in conjunction with signals received from sensors of the engine system, such as the sensors described above with reference to FIG. 1. The controller may employ actuators of the inverter and/or electric motor to adjust electric motor operation, according to the method described below.

In one example, the method 400 may be utilized with the multi-sensor arrangement shown in the example of FIG. 2. The method 400 may account for a torsional deflection of the shaft sensed by the sensors and calculate a torque of the electric motor.

The method 400 begins at 402, which includes receiving feedback from a first sensor. In one example, the first sensor is arranged on a load side (e.g., a first side) of the electric motor. Additionally or alternatively, the first sensor is arranged on a non-load side. The first sensor may provide feedback related to a position of a shaft of the electric motor to a controller.

At 404, the method 400 may include receiving feedback from a second sensor. In one example, the second sensor is arranged on a side of the electric motor opposite to the first sensor. The second sensor may provide feedback related to a position of a shaft of the electric motor to a controller.

At 406, the method 400 may include determining torsional deflection of the shaft based on feedback from the first sensor and the second sensor. For example, when the shaft is subjected to a torque or twisting, a shearing stress is produced in the shaft. The shear stress varies from zero along the center of the shaft to a maximum at an outside surface of the shaft.

The shear stress in a solid circular shaft in a given position can be expressed as:

τ=Tr/J (equation 1)

In equation 1 above, τ=shear stress (Pa, lbf/ft2 (psf)), T=twisting torque (Nm, lbf ft), r=distance from center to stressed surface in the given position (m, ft), and J=Polar Moment of Inertia of Area (m4, ft4).

Thus, torque for a circular shaft may be calculated based on the shear stress determined via equation 1 as:

Tₘₐₓ=τₘₐₓJ/R (equation 2)

In equation 2, Tₘₐₓ=maximum twisting torque (Nm, lb_{f} ft), τₘₐₓ=maximum shear stress (Pa, lb_{f}/ft2), R=radius of shaft (m, ft).

Based on a configuration of the shaft, such as solid or hollow, different equations may be used to determine torque. Polar Moment of Inertia of a circular solid shaft may be expressed as:

J=πR⁴/2=π(D/2)⁴/2=πD⁴/32 (equation 3a)

In equation 3a, D=shaft outside diameter (m, in).

Polar Moment of Inertia of a circular hollow shaft may be expressed as:

J=π(D⁴−d⁴)/32 (equation 3b)

In equation 3b, d=shaft inside diameter (m, ft)

The diameter of the solid shaft (D), may be expressed as:

D=1.72(Tₘₐₓ/τₘₐₓ)^{1/3} (equation 4)

Equations 2 and 3a may be combined to determine the maximum twisting torque (Tₘₐₓ) of a solid shaft as follows:

Tₘₐₓ=(π/16)τₘₐₓD³ (equation 5a)

Equations 2 and 3b may be combined to determine the maximum twisting torque (Tₘₐₓ) of a hollow shaft as follows:

Tₘₐₓ=(π/16)τₘₐₓ(D⁴−d⁴)/D (equation 5b)

Determining the torsional deflection may further include determining the angular deflection of a shaft, which may be expressed as:

α=LT/(JG) (equation 6)

In equation 6, α=angular shaft deflection (radians), L=length of shaft (m, ft), G=Shear Modulus of Rigidity or Modulus of Rigidity (Pa, psf).

The angular deflection of a torsion solid shaft can be expressed as

α=32LT/(G×D⁴) (equation 7a)

The angular deflection of a torsion hollow shaft can be expressed as:

α=32LT/(Gπ(D⁴−d⁴)) (equation 7b)

The angle in degrees can be achieved by multiplying the angle θ in radians with 180/π, as shown in equations 8a and 8b below.

The angle for a solid shaft (π replaced) is expressed as:

α_{degrees}≈584LT/(GD⁴) (equation 8a)

The angle for a hollow shaft (π replaced) is expressed as:

α_{degrees}≈584LT/(G(D⁴−d⁴) (equation 8b)

By measuring continuously, feedback from the first sensor and the second sensor may be used to calculate their difference in a sensed position of the shaft and determine an absolute position that corresponds to the deflection angle. This angle, calculated by equation 8a or 8b depending on a shaft construction, is directly proportional to the load torque calculated in equation 5a or 5b. In this way, the torque may be directly based on the angle and the deflection of the shaft sensed by the first sensor and the second sensor.

The two positions, one from the first sensor and one from the second sensor, used to calculate the deflection angle may be sampled simultaneously to provide an accurate measurement of torque. In one example, to provide a desired consistency, feedback from the first sensor and the second sensor is sampled at the same time. If the positions are sent through a low-speed communication bus, where same delays can occur, it may be demanded to send the position and its timestamp together (in a single message) to execute the calculation. In this way, the logic (e.g., instructions stored in memory of the controller) of the controller may use angles with identical timestamps to calculate the deflection angle and torque of the electric motor.

In one example, both positive (e.g., clockwise) or negative (e.g., counterclockwise) torques may be measured. In one example, the difference between the two position sensors will be positive and in the other case negative.

At 408, the method 400 may include determining if the measured torque value is equal to a commanded value. The commanded value may be based on a torque limit of the shaft, the electric motor, or customer demand. The commanded value may be a non-zero number. The commanded value may be based on operating conditions such as driver demand and/or pedal actuation.

If the measured torque value is equal to the commanded value, then at 410, the method 400 may include maintaining current operating parameters. Signals sent from the controller, to the inverter, may not be adjusted and the inverter may maintain current operation of the electric motor.

If the measured torque value is different than (e.g., unequal to) the commanded value, then at 412, the method 400 may include adjusting the electric motor torque. Adjusting the electric motor torque may include adjusting a signal provided by the controller to the inverter to adjust operation of the electric motor. In one example, if the measured torque value is greater than the commanded value, then the inverter may be signaled to decrease a torque of the electric motor. If the measured torque value is less than the commanded value, then the inverter may be signaled to increase a torque of the electric motor. The electric motor torque may be measured following the adjustment and again modified if the measured torque does not match the commanded value.

FIG. 1 is drawn schematically. FIG. 2 is drawn approximately to scale though other relative dimensions may be used. As used herein, the term “approximately” is construed to mean plus or minus five percent of the range unless otherwise specified. FIGS. 1-2 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The disclosure provides support for a system including a first sensor arranged at a first end of a motor and a second sensor at a second end of the motor, opposite the first end, and a controller with instructions stored in memory that cause the controller to determine a deflection of a shaft of the motor and calculate a torque of the motor. A first example of the system further includes where the first end is a load end of the motor. A second example of the system, optionally including the first example, further includes where the first sensor and the second sensor are arranged outside of a housing of the motor. A third example of the system, optionally including one or more of the previous examples, further includes where the motor is an electric motor. A fourth example of the system, optionally including one or more of the previous examples, further includes where the deflection is based on a position of the shaft of the motor sensed by the first sensor and a position of the shaft sensed by the second sensor. A fifth example of the system, optionally including one or more of the previous examples, further includes where the instructions further cause the controller to adjust operation of the motor in response to the torque being unequal to a commanded torque.

The disclosure provides additional support for a method for an electric motor including a first sensor and a second sensor arranged on a shaft of the electric motor, the method, including measuring a deflection of the shaft based on feedback from the first sensor and the second sensor and calculating a torque applied to the shaft based on the deflection of the shaft. A first example of the method further includes where adjusting operation of the electric motor in response to the torque being unequal to a commanded torque. A second example of the method, optionally including the first example, further includes where the deflection of the shaft includes a shear stress and an angular deflection. A third example of the method, optionally including one or more of the previous examples, further includes where the shaft is solid. A fourth example of the method, optionally including one or more of the previous examples, further includes where the shaft is hollow. A fifth example of the method, optionally including one or more of the previous examples, further includes where the electric motor is coupled to an inverter. A sixth example of the method, optionally including one or more of the previous examples, further includes correcting an offset between the first sensor and the second sensor when the torque is zero. A seventh example of the method, optionally including one or more of the previous examples, further includes where the first sensor and the second sensor are position sensors. An eighth example of the method, optionally including one or more of the previous examples, further includes where the first sensor and the second sensor are identical.

The disclosure provides further support for a system including an electric motor, a shaft coupled to the electric motor, a first sensor arranged on the shaft adjacent to a first side of the electric motor, a second sensor arranged on the shaft adjacent to a second side of the electric motor, the second side opposite the first side, and a controller comprising computer-readable instructions stored in memory thereof that when executed cause the controller to measure a deflection of the shaft based on feedback from the first sensor and the second sensor, and calculate a torque of the shaft directly based on the deflection. A first example of the system further includes where an inverter is coupled to the electric motor, and wherein the instructions further cause the controller to adjust commands sent to the inverter to adjust operation of the electric motor in response to the torque being unequal to a commanded torque. A second example of the system, optionally including the first example, further includes where the first sensor is arranged between a gear and the electric motor. A third example of the system, optionally including one or more of the previous examples, further includes where the deflection accounts for an angular deflection and a shear stress of the shaft. A fourth example of the system, optionally including one or more of the previous examples, further includes where the electric motor comprises a housing, and wherein the first sensor and the second sensor are pressed against exterior surfaces of the housing.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a first sensor arranged at a first end of a motor and a second sensor at a second end of the motor, opposite the first end; and
a controller with instructions stored in memory that cause the controller to:
determine a deflection of a shaft of the motor and calculate a torque of the motor.

2. The system of claim 1, wherein the first end is a load end of the motor.

3. The system of claim 1, wherein the first sensor and the second sensor are arranged outside of a housing of the motor.

4. The system of claim 1, wherein the motor is an electric motor.

5. The system of claim 1, wherein the deflection is based on a position of the shaft of the motor sensed by the first sensor and a position of the shaft sensed by the second sensor.

6. The system of claim 1, wherein the instructions further cause the controller to adjust operation of the motor in response to the torque being unequal to a commanded torque.

7. A method for an electric motor comprising a first sensor and a second sensor arranged on a shaft of the electric motor, the method, comprising:
measuring a deflection of the shaft based on feedback from the first sensor and the second sensor; and
calculating a torque applied to the shaft based on the deflection of the shaft.

8. The method of claim 7, further comprising adjusting operation of the electric motor in response to the torque being unequal to a commanded torque.

9. The method of claim 7, wherein the deflection of the shaft includes a shear stress and an angular deflection.

10. The method of claim 7, wherein the shaft is solid.

11. The method of claim 7, wherein the shaft is hollow.

12. The method of claim 7, wherein the electric motor is coupled to an inverter.

13. The method of claim 7, further comprising correcting an offset between the first sensor and the second sensor when the torque is zero.

14. The method of claim 7, wherein the first sensor and the second sensor are position sensors.

15. The method of claim 7, wherein the first sensor and the second sensor are identical.

16. A system, comprising:
an electric motor;
a shaft coupled to the electric motor;
a first sensor arranged on the shaft adjacent to a first side of the electric motor;
a second sensor arranged on the shaft adjacent to a second side of the electric motor, the second side opposite the first side; and
a controller comprising computer-readable instructions stored in memory thereof that when executed cause the controller to:
measure a deflection of the shaft based on feedback from the first sensor and the second sensor; and
calculate a torque of the shaft directly based on the deflection.

17. The system of claim 16, wherein an inverter is coupled to the electric motor, and wherein the instructions further cause the controller to adjust commands sent to the inverter to adjust operation of the electric motor in response to the torque being unequal to a commanded torque.

18. The system of claim 16, wherein the first sensor is arranged between a gear and the electric motor.

19. The system of claim 16, wherein the deflection accounts for an angular deflection and a shear stress of the shaft.

20. The system of claim 16, wherein the electric motor comprises a housing, and wherein the first sensor and the second sensor are pressed against exterior surfaces of the housing.
